(19) United States
(12) Patent Application Publication
(10) Pub. No.: US 2019/0047230 A1
(43) Pub. Date: Feb. 14, 2019

(54) HEAT-SEAL APPARATUS AND METHOD THEREOF

(71) Applicant: Tung-Lung Chiang, New Taipei City (TW)

(72) Inventor: Tung-Lung Chiang, New Taipei City (TW)

(21) Appl. No.: 15/970,864

(22) Filed: May 3, 2018

(30) Foreign Application Priority Data
Aug. 10, 2017 (TW) 106127045

(51) Int. Cl. B29C 65/32; B29C 65/00

(52) U.S. Cl. CPC B29C 65/32; B29C 66/91231; B29L 2007/008; B29C 66/72; B29C 66/91421

(57) ABSTRACT

A heat-seal apparatus of an air-bubble machine and the method thereof, comprising: an air-bubble machine main-body; at least one electromagnetic heating assembly for producing a magnetic force; at least one magnetically conductive heat-seal assembly to heat-seal at least one air-bubble film; at least one support-portion to make an interval space between the electromagnetic heating assembly and the magnetically conductive heat-seal assembly; and at least one transmission shaft-body. The magnetic force generated by the electromagnetic heating assembly passes through the interval space to mutually interact with the magnetically conductive heat-seal assembly by electromagnetic induction, and the magnetically conductive heat-seal assembly is heated in a non-contact manner to make the heating be very rapid and uniform. The magnetically conductive heat-seal assembly is driven by the transmission shaft-body to move the air-bubble film which is simultaneously heat-sealed when being moved, thereby improving the use efficiency of energy.

### (a) TECHNICAL FIELD OF THE INVENTION

The present invention provides a heat-seal apparatus of an air-bubble machine and the method thereof, and especially relates to an air-bubble machine and the method thereof which utilizes the electromagnetic induction to heat the magnetically conductive heat-seal assembly in a non-contact manner, so that the heating is more rapid and uniform, the operating temperature can be stably controlled, and the effect of saving energy can be achieved.

### (b) DESCRIPTION OF THE PRIOR ART

The air-bubble film is an inflatable cushioning material used for packaging articles, and the air is poured into the closed bag-body, so that the bag-body is propped up to form a buffer protection structure.

At present, the air-bubble film is a globally popular packaging material because its characteristics are in line with the requirements of the contemporary environmental protection and more effective utilization for storage space.

And, it is more beautiful and protective compared with the traditional packaging materials. Therefore, many internationally renowned companies use air-bubble film to package goods.

The conventional air-bubble machine for the production of the air-bubble film generally use the heating element such as the hot-pressing strip or the heating plate as the sealing device.

When the air-bubble film is transported by the guide roller and pass under the sealing device, the heating element must butt-hold, and press the air-bubble film from one end all the way to the other end to complete the sealing action because the heating element is fixed in one side of the path of the air-bubble film.

However, it is true that the following problems and lacks are still to be improved when the above-mentioned air-bubble machine is used:
1. The conventional air-bubble machine uses the Nichrome wire combined with the roller as the heating element to heat by the electrical energization, the two ends of the Nichrome wire must be kept apart in order to prevent the Nichrome wire from short-circuiting. Such that, the problem of unsightly or incomplete closure is produced.
2. The heating element of the air-bubble machine is heated in a contact manner, which will affect the operation of the heating element and have a problem of excessive energy consumption.
3. The heating element of the air-bubble machine can also be heated in a non-contact manner by infrared rays, but it has a problem that the heating efficiency is too low.

### SUMMARY OF THE INVENTION

The main purpose of the present invention is: Through the designs of the electromagnetic heating assembly and the magnetically conductive heat-seal assembly, the electromagnetic heating assembly is mutually interacted with the magnetically conductive heat-seal assembly by the electromagnetic induction. And, the magnetically conductive heat-seal assembly is heated in a non-contact manner by the electromagnetic heating assembly to make the heating more rapid and uniform; and the operating temperature can be stably controlled, so that the present invention can achieve the effect of energy saving.

The main structure of the present invention that can achieve the above purpose comprises: an air-bubble machine main-body set with at least one electromagnetic heating assembly for producing a magnetic force; at least one magnetically conductive heat-seal assembly set on the air-bubble machine main-body and located at the side of the electromagnetic heating assembly; wherein the magnetically conductive heat-seal assembly is heated to heat-seal at least one air-bubble film by the electromagnetic induction of the magnetic force; at least one support-portion defined on the air-bubble machine main-body and connected to the electromagnetic heating assembly to support the electromagnetic heating assembly and make an interval space between the electromagnetic heating assembly and the magnetically conductive heat-seal assembly; and at least one transmission shaft-body set on the magnetically conductive heat-seal assembly; thereby the support-portion can be utilized to support the electromagnetic heating assembly and make an interval space between the electromagnetic heating assembly and the magnetically conductive heat-seal assembly when the magnetically conductive heat-seal assembly and the electromagnetic heating assembly are set on the air-bubble machine main-body, and a magnetic force is generated by utilizing the electromagnetic heating assembly; wherein the magnetic force passes through the interval space to mutually interact with the magnetically conductive heat-seal assembly by electromagnetic induction, and the magnetically conductive heat-seal assembly is heated in a non-contact manner to make the heating of the magnetically conductive heat-seal assembly be very rapid and uniform; thereby the user can also stably control the operating temperature, and the magnetically conductive heat-seal assembly is driven by the transmission shaft-body to move the air-bubble film; when being moved by the magnetically conductive heat-seal assembly, the air-bubble film is simultaneously heat-sealed, thereby improving the use efficiency of energy.

By applying the above-mentioned techniques, the present invention breaks through and solves the problems existed in the conventional air-bubble machine, such as: being unsightly, incomplete closure, heating in a contact manner will affect the operation of the heating element and consume excessive energy, and heating by infrared rays will have low efficiency; therefore the present invention having the above-mentioned advantages achieves the practical improvement.

### BRIEF DESCRIPTION OF THE DRAWINGS

FIG. 1 is a perspective view of the preferred embodiment according to the present invention.

FIG. 2 is a decomposition diagram of the preferred embodiment according to the present invention.

FIG. 3 is a partial side view of the preferred embodiment according to the present invention.

FIG. 4 is a process block diagram of the preferred embodiment according to the present invention.

FIG. 5 is a implementation schematic diagram of the preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

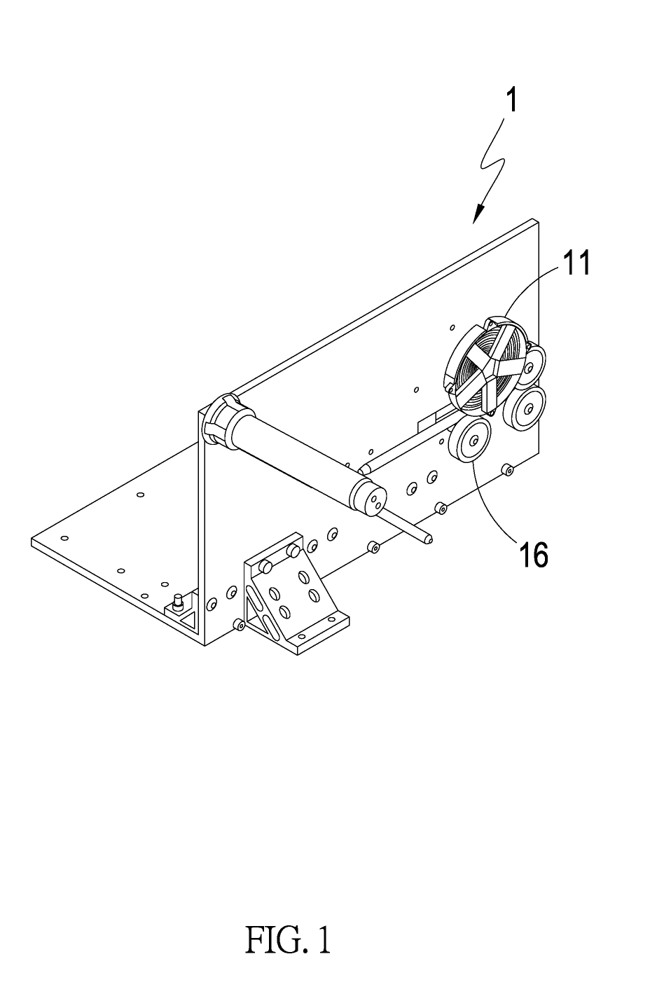

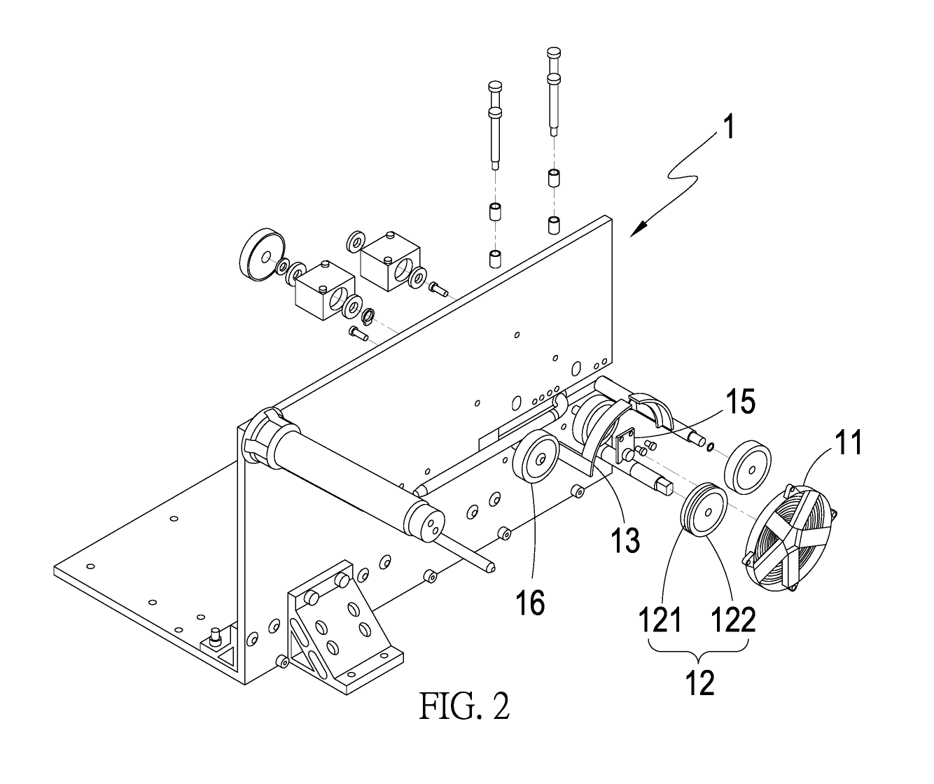

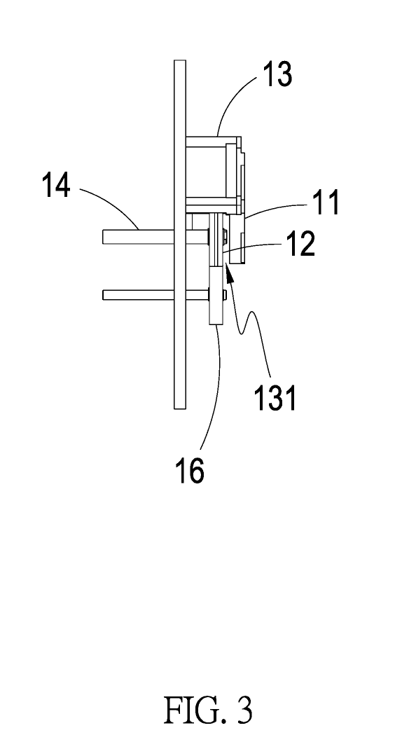

Please refer to FIG. 1 to FIG. 3 which are a perspective view to a partial side view of the preferred embodiment of the present invention. It can be clearly seen from the drawings that the present invention comprises: an air-bubble machine main-body 1 set with at least one electromagnetic heating assembly 11 for producing a magnetic force; at least one magnetically conductive heat-seal assembly 12 set on the air-bubble machine main-body 1 and located at the side of the electromagnetic heating assembly 11; wherein the magnetically conductive heat-seal assembly 12 comprises at least one magnetically conductive heat-sealing element 121 and at least one friction element 122 set on the magnetically conductive heat-sealing element 121; wherein the material of the magnetically conductive heat-sealing element 121 is one of Iron, Rubidium, Boron, Cobalt, or Nickel; and the magnetically conductive heat-seal assembly 12 is heated to heat-seal at least one air-bubble film through the electromagnetic induction of the magnetic force; at least one support-portion 13 defined on the air-bubble machine main-body 1 and connected to the electromagnetic heating assembly 11 to support the electromagnetic heating assembly 11 and make an interval space 131 between the electromagnetic heating assembly 11 and the magnetically conductive heat-seal assembly 12; at least one transmission shaft-body 14 set on the magnetically conductive heat-seal assembly 12; and at least one temperature sensing-element 15 set in the side of the magnetically conductive heat-seal assembly 12 and at least one abut-hold element 16 set at the side of the magnetically conductive heat-seal assembly 12.

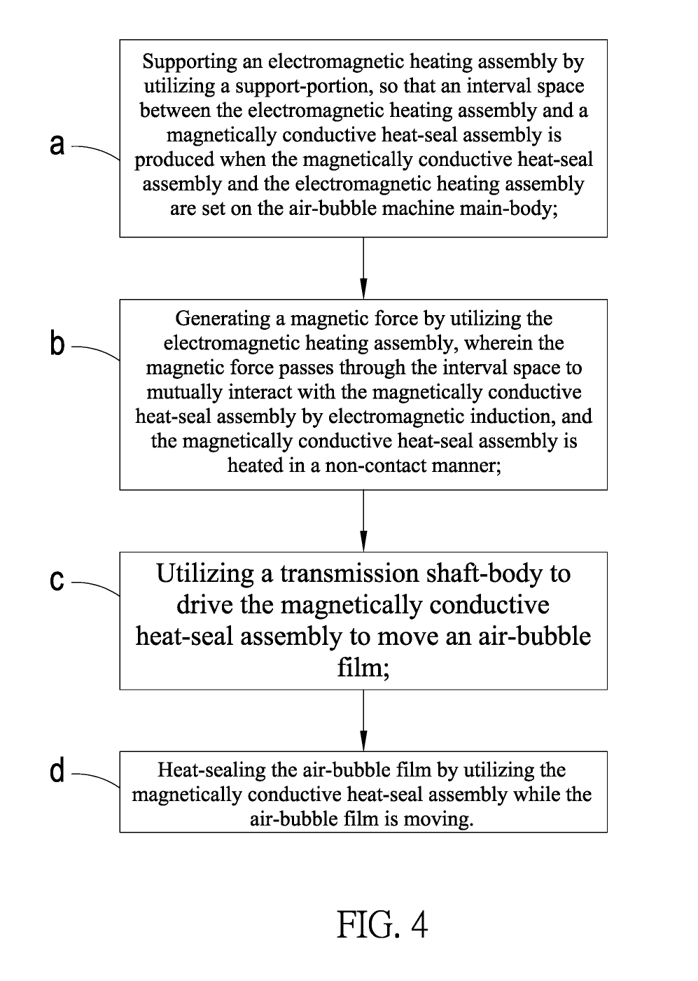

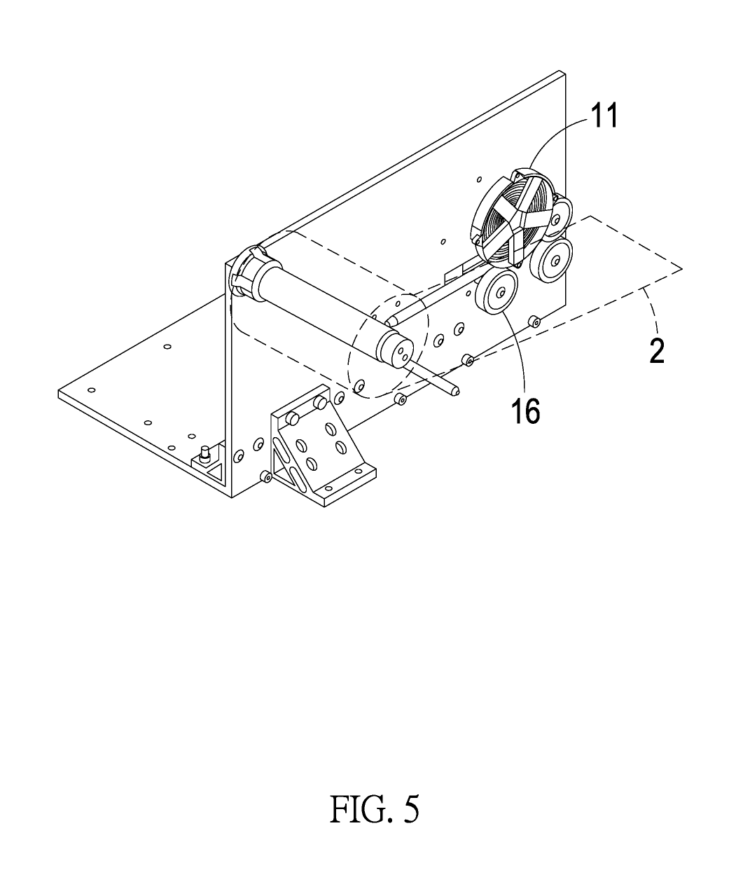

Please refer to FIG. 1 to FIG. 5 at the same time, which are a perspective view to an implementation schematic diagram of the preferred embodiment of the present invention. It can be clearly seen from the drawings that the main heat-seal method of the present invention majorly comprises:

(a) Supporting the electromagnetic heating assembly 11 by utilizing the support-portion 13, so that an interval space 131 between the electromagnetic heating assembly 11 and the magnetically conductive heat-seal assembly 12 is produced when the magnetically conductive heat-seal assembly 12 and the electromagnetic heating assembly 11 are set on the air-bubble machine main-body 1;

(b) Generating a magnetic force by utilizing the electromagnetic heating assembly 11, wherein the magnetic force passes through the interval space 131 to mutually interact with the magnetically conductive heat-seal assembly 12 by electromagnetic induction, and the magnetically conductive heat-seal assembly 12 is heated in a non-contact manner;

(c) Utilizing the transmission shaft-body 14 to drive the magnetically conductive heat-seal assembly 12 to move the air-bubble film 2;

(d) Heat-sealing the air-bubble film 2 by utilizing the magnetically conductive heat-seal assembly 12 while the air-bubble film 2 is moving.

To further explain the above steps in detail, the user can place the air-bubble film 2 on the air-bubble machine main-body 1, and the electromagnetic heating assembly 11 is a coil which can generate a constantly changing magnetic field; and the magnetically conductive heat-sealing element 121 on the magnetically conductive heat-seal assembly 12 is a magnetically conductive material which is one of Iron, Rubidium, Boron, Cobalt, or Nickel.

The magnetically conductive heat-seal assembly 12 is supported on the air-bubble machine main-body 1 by the support-portion 13 and has an interval space 131 in between with the electromagnetic heating assembly 11. The magnetic force generated by the electromagnetic heating assembly 11 passes through the interval space 131 to mutually interact with the magnetically conductive heat-seal assembly 12 by electromagnetic induction, and the magnetically conductive heat-seal assembly 12 is heated in a non-contact manner. The heating principle is as follows: the electromagnetic heating assembly 11 has a control circuit which can convert the direct current into a high-frequency current (a current that changes direction regularly). The high-frequency current passes inside the electromagnetic heating assembly 11, so the electromagnetic heating assembly 11 generates a magnetic field that constantly changes direction, and the magnetic force generated by the electromagnetic heating assembly 11 will pass through the interval space 131 to mutually interact with the magnetically conductive heat-seal assembly 12 by electromagnetic induction.

And, the magnetically conductive heat-seal assembly 12 can generate eddy currents by electromagnetic induction. When the eddy currents are affected by the resistance of the magnetically conductive heat-seal assembly 12 itself, the heat energy is generated to achieve the heating effect. Thereby the magnetically conductive heat-seal assembly 12 is heated by the electromagnetic heating assembly 11 in a non-contact manner, therefore the interval space 131 between the electromagnetic heating assembly 11 and the magnetically conductive heat-seal assembly 12 needs to be a proper distance. If the interval space 131 is too large, then the electromagnetic heating assembly 11 needs to pass a large current to heat the magnetically conductive heat-seal assembly 12. If the interval space 131 is too small, the electromagnetic heating element 11 and the magnetically conductive heat-seal assembly 12 may be in contact with each other because of the mechanical errors of themselves and thus the electromagnetic induction heating cannot be performed. Furthermore, the magnetically conductive heat-seal assembly 12 is driven by the transmission shaft-body 14 to rotate after the magnetically conductive heat-seal assembly 12 is heated, and the air-bubble film 2 is sandwiched between the magnetically conductive heat-seal assembly 12 and the abut-hold element 16. The magnetically conductive heat-seal assembly 12 and the abut-hold element 16 of this embodiment are both in the form of a roller. When the magnetically conductive heat-seal assembly 12 rotates, the air-bubble film 2 is moved. At the same time, the air-bubble film 2 is heat-sealed by the magnetically conductive heat-seal assembly 12 and the magnetically conductive heat-seal assembly 12 has a friction element 122 of rubber material. The friction element 122 has a high coefficient of friction, so that the magnetically conductive heat-seal assembly 12 is capable of driving the air-bubble film 2. The surface of the magnetically conductive heat-seal assembly 12 can further contains a Teflon, so that the air-bubble film 2 will not stick to the magnetically conductive heat-seal assembly 12 during the heat-seal operation. And, a temperature sensing-element 15 is set at the side of the magnetically conductive heat-seal assembly 12. The temperature sensing-element 15 is a thermometer and can sense the temperature of the magnetically conductive heat-seal assembly 12. Such that, the air-bubble machine main-body 1 can maintain the magnetically conductive heat-seal assembly 12 at an appropriate working temperature, so that the user can stably control the operating temperature. Therefore, the heating can also be more rapid and uniform, so that the present invention can achieve the effect of energy saving. In addition, a magnetic shielding device may also be added to the present invention to shield the magnetic force generated by the electromagnetic heating assembly 11; so as to prevent the heart rhythm regulator in the human body from being interfered with by the magnetic force, thereby causing danger.

Therefore, the technical key for improving the conventional technology according to the heat-seal apparatus and the method thereof of the present invention is lied in that: Through the designs of the electromagnetic heating assembly 11 and the magnetically conductive heat-seal assembly 12, the electromagnetic heating assembly 11 is mutually interacted with the magnetically conductive heat-seal assembly 12 by the electromagnetic induction. And, the magnetically conductive heat-seal assembly 12 is heated in a non-contact manner by the electromagnetic heating assembly 11 to make the heating more rapid and uniform; and the operating temperature can be stably controlled, so that the present invention can achieve the effect of energy saving.

I claim:

1. A heat-seal apparatus of an air-bubble machine, which mainly comprises:
an air-bubble machine main-body;
at least one electromagnetic heating assembly set on the air-bubble machine main-body for producing a magnetic force;
at least one magnetically conductive heat-seal assembly set on the air-bubble machine main-body and located at the side of the electromagnetic heating assembly; wherein the magnetically conductive heat-seal assembly is heated to heat-seal at least one air-bubble film by the electromagnetic induction of the magnetic force;
at least one support-portion defined on the air-bubble machine main-body and connected to the electromagnetic heating assembly to support the electromagnetic heating assembly and make an interval space between the electromagnetic heating assembly and the magnetically conductive heat-seal assembly; and
at least one transmission shaft-body set on the magnetically conductive heat-seal assembly.

2. The heat-seal apparatus of an air-bubble machine according to claim 1, wherein at least one temperature sensing-element is set in the side of the magnetically conductive heat-seal assembly.

3. The heat-seal apparatus of an air-bubble machine according to claim 1, wherein at least one abut-hold element is set in the side of the magnetically conductive heat-seal assembly.

4. The heat-seal apparatus of an air-bubble machine according to claim 1, wherein the magnetically conductive heat-seal assembly comprises at least one magnetically conductive heat-sealing element and at least one friction element set on the magnetically conductive heat-sealing element.

5. The heat-seal apparatus of an air-bubble machine according to claim 4, wherein the material of the magnetically conductive heat-sealing element is one of Iron, Rubidium, Boron, Cobalt, or Nickel.

6. A heat-seal method of an air-bubble machine, which the method mainly comprises:
(a) Supporting an electromagnetic heating assembly by utilizing a support-portion, so that an interval space between the electromagnetic heating assembly and a magnetically conductive heat-seal assembly is produced when the magnetically conductive heat-seal assembly and the electromagnetic heating assembly are set on the air-bubble machine main-body;
(b) Generating a magnetic force by utilizing the electromagnetic heating assembly, wherein the magnetic force passes through the interval space to mutually interact with the magnetically conductive heat-seal assembly by electromagnetic induction, and the magnetically conductive heat-seal assembly is heated in a non-contact manner;
(c) Utilizing a transmission shaft-body to drive the magnetically conductive heat-seal assembly to move an air-bubble film;
(d) Heat-sealing the air-bubble film by utilizing the magnetically conductive heat-seal assembly while the air-bubble film is moving.

7. The heat-seal method of an air-bubble machine according to claim 6, wherein at least one temperature sensing-element is set in the side of the magnetically conductive heat-seal assembly.

8. The heat-seal method of an air-bubble machine according to claim 6, wherein at least one abut-hold element is set in the side of the magnetically conductive heat-seal assembly.

9. The heat-seal method of an air-bubble machine according to claim 6, wherein the magnetically conductive heat-seal assembly comprises at least one magnetically conductive heat-sealing element and at least one friction element set on the magnetically conductive heat-sealing element.

10. The heat-seal method of an air-bubble machine according to claim 9, wherein the material of the magnetically conductive heat-sealing element is one of Iron, Rubidium, Boron, Cobalt, or Nickel.
